(19) United States
(12) Patent Application Publication
(10) Pub. No.: US 2025/0384332 A1
(43) Pub. Date: Dec. 18, 2025

(54) System and Method for Real-Time Optimization of Retrieval Augmented Generation (RAG) Hyperparameters

(71) Applicant: Microsoft Technology Licensing, LLC, Redmond, WA (US)

(72) Inventors: Laurent Boué, Petah Tikva (IL); Yasmin Bokobza, Ramat Gan (IL); Kiran Rama, Bangalore (IN); Naveen Panwar, Bengaluru (IN)

(21) Appl. No.: 18/744,903

(22) Filed: Jun. 17, 2024

(51) Int. Cl. G06N 20/00

(52) U.S. Cl. CPC G06N 20/00

(57) ABSTRACT

A method, computer program product, and computing system for processing a query provided to a generative AI model. A content portion retrieved by a Retrieval Augmented Generation system for the query is processed. User context information associated with a user providing the query is determined. Hyperparameters are generated for processing the prompt with the generative AI model by processing the query, the content portion, and the user context information using run-time surrogate model inversion optimization.

### BACKGROUND

With the prevalence of generative artificial intelligence (AI) models, such as large language models (LLMs), question/answering (QA) systems are now powering many applications across various business environments. In some instances, a query that a user provides is given as input to the LLM, along an appropriate context, which is the text that the LLM should “search” for in an answer, a technique that is called prompt engineering. The main problem with this approach is that the size of the prompt is limited. For example, the limit for GPT3.5-Turbo is 4,096 tokens, the limit for GPT4 is 8,192 tokens, and the limit for GPT-4-32 k is 32,768 tokens. Documents or other content that can be searched using the LLM are often orders of magnitude larger than the prompt size limit. For example, the size of a single document could be twenty megabytes, and the size of the complete set of relevant documents and knowledge base articles ranges between hundreds of megabytes to hundreds of gigabytes. Accordingly, a Retrieval Augmented Generation (RAG) system is used to break input documents into content portions that are small enough to fit the prompt size limitations. It then uses common indexing and retrieval techniques to match user queries to the most relevant content portions, and then combines the user query and context (one or more content portions) as a prompt to the LLM and presents the answers to the user.

The LLM-generated output of RAG (Retrieval Augmented Generation) systems provides parameters that are user-controllable such as the randomness of the generated text (temperature), restricting to the top-most answers from the underlying LLM (top “p” answers), control the amount of text generated (response length), control the level of repetition in responses (frequency or presence), generate multiple responses to a query (best of), etc. These are definable via a programming language. However, common approaches set these to the same values for most queries of RAG systems regardless of the user or the context associated with the queries being processed.

### BRIEF DESCRIPTION OF THE DRAWINGS

FIG. 1 is a flow chart of an implementation of a hyperparameter generation process;

FIGS. 2-4 are diagrammatic views of the hyperparameter generation process of FIG. 1; and

FIG. 5 is a diagrammatic view of computer system and the hyperparameter generation process coupled to a distributed computing network.

Like reference symbols in the various drawings indicate like elements.

### DETAILED DESCRIPTION OF THE EMBODIMENTS

Implementations of the present disclosure generate RAG hyperparameters dynamically depending on the query, the user, and the retrieved content so as to maximize a predicted user feedback. For example, the hyperparameter generation process provides a way to specify hyperparameters of a generative AI model (e.g., parameters like temperature, top “p” answers, response length, frequency of response) that are customizable to the user and/or the query. Given the closed nature of LLM systems (as most LLMs are not open-source, most LLMs have restrictive licensing of some form, where the training data/time periods for training the LLM are not public knowledge, etc.), the ability to optimize the LLM parameters that are user-customized or query-customized provide greater control over information retrieval (i.e., by determining how many content portions to use in a prompt), the randomness of the generated text (i.e., information retrieval or creative content), balance of efficiency and performance (i.e., by determining batch size of queries processed simultaneously, or breadth of exploration during generation impacting computing cost and quality), and/or adapting to specific use cases for users or queries (i.e., with result generation for particular users or queries).

Accordingly, implementations of the present disclosure optimize the RAG parameters per user query. For example, the hyperparameter generation process provides a modified RAG inference architecture, where, in the RAG system, once the top-k similar documents are retrieved, the embeddings for the query and the top-k sources, along-with the side information (of users and the environment), are input to a surrogate machine learning model that predicts the most likely hyperparameters to use for the LLM. The surrogate machine learning model uses the user feedback as the target of optimization, and the embeddings of the top “k” data sources, the embeddings of the user query, and user context information as features to tune. In some implementations, as the hyperparameter generation process maintains a log of the LLM hyperparameters that were used to answer previous queries, the hyperparameter generation process predicts the user feedback for a set of hyperparameters along with the above-mentioned features, enabling the ranking of potential hyperparameters at run-time.

In some implementations, the hyperparameter generation process optimizes the hyperparameters of RAG systems without requiring access to the internals of the LLMs and can be performed in real-time as the queries come to a QA system (e.g., a generative AI model of a QA system). This involves collecting a telemetry dataset of users' feedback on existing QA systems which is used to train a supervised machine learning model to predict user feedback. This surrogate machine learning model is then inverted and inserted back into the RAG architecture to provide real-time optimal hyperparameters that are context and user dependent. Accordingly, the hyperparameter generation process can be performed on any black box proprietary RAG system. Additionally, the optimized hyperparameters are query-dependent and user context-dependent as these are recalculated in real-time for each new query.

The details of one or more implementations are set forth in the accompanying drawings and the description below. Other features and advantages will become apparent from the description, the drawings, and the claims.

### The Hyperparameter Generation Process:

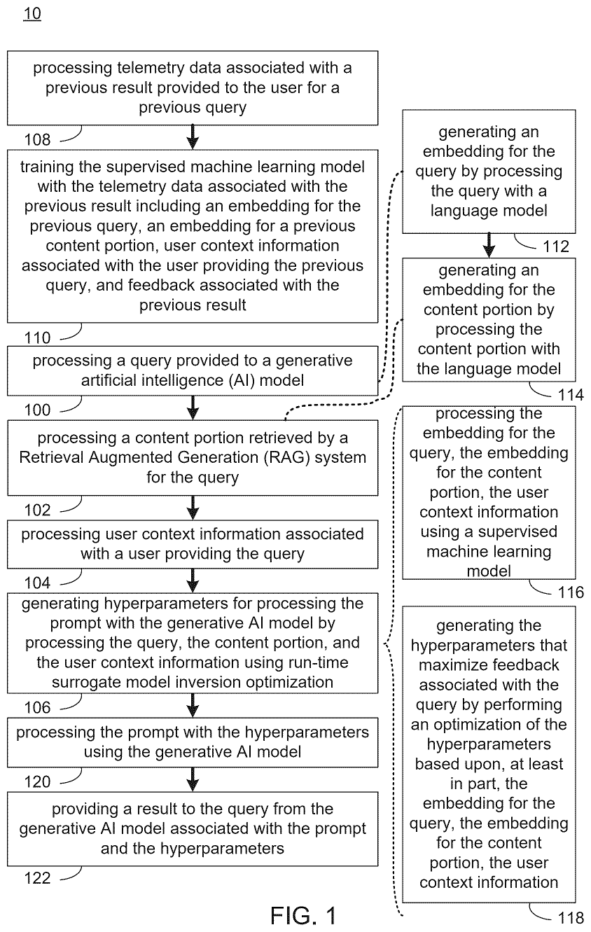

Referring to FIG. 1-4, hyperparameter generation process 10 processes 100 a query provided to a generative AI model. A content portion retrieved by a Retrieval Augmented Generation system for the query is processed 102. User context information associated with a user providing the query is processed 104. Hyperparameters are generated 106 for processing the prompt with the generative AI model by processing the query, the content portion, and the user context information using run-time surrogate model inversion optimization.

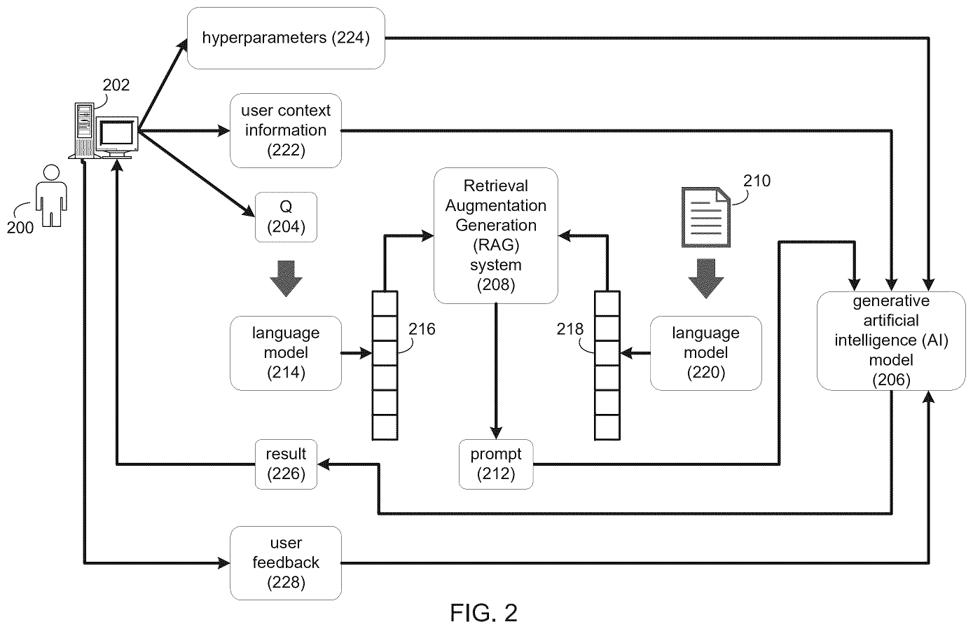

In some implementations, hyperparameter generation process 10 processes 108 telemetry data with a previous result provided to a user for a previous query. Referring also to FIG. 2, one example of the use of a Retrieval Augmented Generation (RAG) system with a generative artificial intelligence (AI) model is shown. For example, a user (e.g., user 200) may use a computing device (e.g., computing device 202) to process a query (e.g., query 204) using a generative AI model. Query 204 is a request from a user for information from a document or a plurality of documents. In one example, query 204 may include a text string in the form of a request or a question. In another example, query 204 may be initially received as a recorded audio request from a user that is converted into a machine-readable version of the audio signal and/or converted to text (e.g., using an automated speech recognition system). A generative AI model (e.g., generative AI model 206) is an algorithm and/or system that processes natural language prompts and/or example entries and/or contextual information concerning an incident to generate a response. In some implementations, generative AI model 200 includes a Large Language Model (LLM). A LLM is a language model consisting of a neural network with many parameters (typically billions of weights or more), trained on large quantities of unlabeled text using self-supervised learning or semi-supervised learning. Though trained on simple tasks along the lines of predicting the next word in a sentence, LLMs with sufficient training and parameter counts capture the syntax and semantics of human language or specific patterns.

In some implementations, hyperparameter generation process 10 processes the query using a Retrieval Augmented Generation (RAG) system. For example and as discussed above, a RAG system (e.g., RAG system 208) is a system that is used to break relevant input documents into content portions that are small enough to fit prompt size limitations associated with a generative AI model for processing queries upon. Many generative AI models, such as LLMs, are not trained on a particular library of input documents used for a particular scenario. As such, these generative AI models lack the context to process content from the particular library of input documents. Accordingly, RAG system 208 breaks content into chunks or portions (e.g., content portion 210) that are small enough to fit prompt size limitations associated with generative AI model 206. Common indexing and retrieval techniques match user queries to the most relevant content portions, and the user query and context (one or more content portions) are combined as a prompt (e.g., prompt 212) to generative AI model 206.

In some implementations, language model 214 generates a query embedding (e.g., query embedding 216) from query 204. For example, given a user query (e.g., query 204), the query text is transformed into a vector of embeddings (e.g., query embedding 216) by passing each query 204 through a language model (e.g., language model 214) to generate a vector of numbers corresponding to the dimensions for the vector embedding (e.g., query embedding 216). In some implementations, language model 214 converts text into a numerical representation. For example, query embedding 216 is a numerical representation of the semantic meaning of query 204 and allows query 204 to be understood and processed more effectively when comparing against content portion embeddings of an input content portion or other document (e.g., content portion 210). Similarly, RAG system 208 generates a content portion embedding (e.g., content portion embedding 218) from content portion 212 using a language model (e.g., language model 220). In one example, language model 220 is the same as language model 214. In another example, separate language models are used for query processing and content processing.

In some implementations, RAG system 208 identifies a plurality of content portions for inclusion in prompt 212 with query 204 using a content portion similarity score. A content portion similarity score is a numerical representation of the similarity between a content portion embedding and a query embedding. For example, hyperparameter generation process 10 determines or generates a content portion similarity score to each candidate content portion based on of how well it matches a given query. The score is based on the similarity, or distance, between the vector embeddings of the content portion and query. It will be appreciated that any distance metric can be used within the scope of the present disclosure. In one example, hyperparameter generation process 10 determines the content portion similarity score using cosine similarity. Cosine similarity scoring assigns a score in the range of [−1,1], where a score close to “1” means the two vectors are similar (codirectional), a score close to “−1” means the two vectors are opposite, and a score close to “0” means the two vectors are unrelated (orthogonal). In some implementations, hyperparameter generation process 10 limits the score to the range of [0,1] and ignore content portions that have a negative cosine similarity with the query.

In some implementations, RAG system 208 generates a prompt (e.g., prompt 212) using query embedding 216 and the content portion embedding 218 and provides this to generative AI model 206. Using prompt 212, user context information 222, and hyperparameters 224, generative AI model 206 generates result 226 as an “answer” to query 204. In some implementations, hyperparameter generation process 10 receives user feedback (e.g., user feedback 228) from user 200 as a measure of the user's satisfaction with result 226 for query 204.

In some implementations, the combination of prompt 212, query 204, result 226, user context information 222, and/or hyperparameters 224 define telemetry data for generative AI model 206. Accordingly, hyperparameter generation process 10 processes 108 telemetry data (e.g., prompt 212, query 204, result 226, user context information 222, and/or hyperparameters 224) with a previous result (e.g., result 226) provided to a user (e.g., user 200) for a previous query (e.g., query 204).

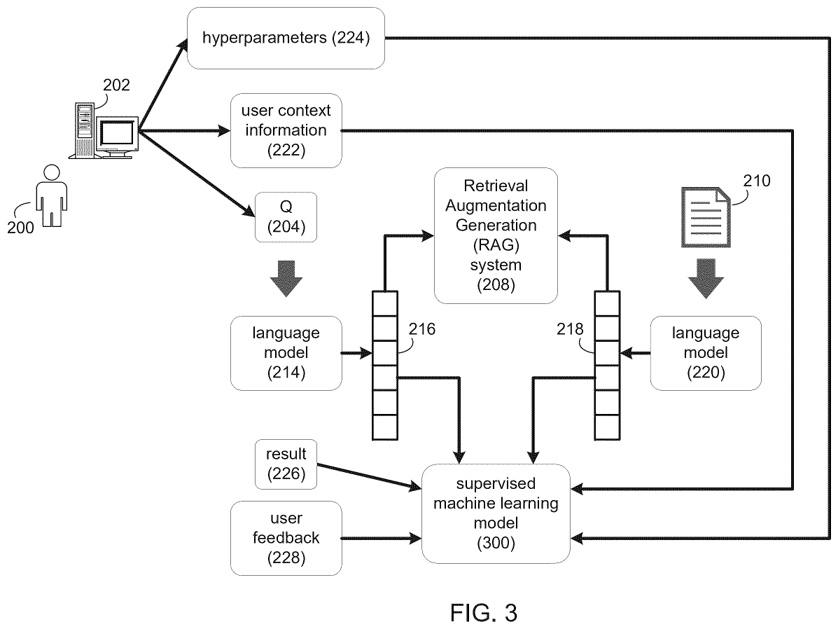

Referring also to FIG. 3 and in some implementations, processing 108 telemetry data includes processing a dataset of previous queries and transforming the questions into embeddings using a language model, (i.e., [eq₁=L(q₁), eq₂=L(q₂), . . . ], where eqᵢ is a respective question with index “i” and L(eqᵢ) is the embedding generated from language model 214 (L)). Hyperparameter generation process 10 collects the top-k source content portions identified using RAG system 208. For a question qᵢ, those [esᵢ₁, esᵢ₂, . . . , esᵢₖ] embeddings can be summarized in an embedding esᵢ=g([esᵢ₁, esᵢ₂, . . . , esᵢₖ]) where g is an aggregating function whose specific implementation may vary from use case to use case. Accordingly, each query is associated with content embeddings [es₁, es₂, . . . ].

In some implementations, hyperparameter generation process 10 collects and processes user context information (e.g., user context information 222) about the user who is currently providing query 204 and the environment from which the query is being asked. For example, this may be the browser, country, and/or software system (e.g., an application, an AI assistant, etc.) from which the query is coming from. All such features are grouped into a symbol ftₛᵢ which is a list of such additional features for query qᵢ. In some implementations, hyperparameter generation process 10 processes the values of the RAG hyperparameters [hprag₁, hprag₂, . . . ] (e.g., hyperparameters 224) which were used to generate the previous result (ai) to the previous query qᵢ. In one example, telemetry data is represented as a combination of data elements with the following schema: (eqᵢ, esᵢ, ftsᵢ hpragᵢ, feedbackᵢ), where the index “i” runs over all the (qᵢ, aᵢ) pairs for which the users provided a feedback value (e.g., user feedback 228). In some implementations, hyperparameter generation process 10 provides about 15-25% exploration with different hyperparameter values in the calls to generative AI model 206. In this manner, hyperparameter generation process 10 is able to train a supervised machine learning model to process different user feedback for varying generative AI model hyperparameters (e.g., hyperparameters 224).

In some implementations, hyperparameter generation process 10 trains 110 a supervised machine learning model with an embedding for the previous query, an embedding for a previous content portion, user context information associated with the user providing the previous query, and feedback associated with the previous result. For example, a supervised machine learning model (e.g., supervised machine learning model 300) is a machine learning algorithm or system that processes labeled data (i.e., training data) to map input data to corresponding output data. In this manner, supervised machine learning model 300 processes new data at run-time (inference) to generate output data with a consistent mapping. Accordingly, supervised machine learning model 300 generates a probability-based result with the highest probability for matching the mapping of the training data for the new data.

In some implementations and given the telemetry dataset discussed above, hyperparameter generation process 10 performs conventional machine learning processing to divide the telemetry dataset into train/test/valid sub-datasets upon which supervised machine learning model 300 is trained. In this example, hyperparameter generation process 10 trains 110 supervised machine learning model 300 to generate a feedback result or score for a given set of query embeddings, content portion embeddings, user context information, and hyperparameters. In some implementations, if the user feedback value is numerical, hyperparameter generation process 10 trains a regression machine learning model. In another example, if the user feedback value is categorical, hyperparameter generation process 10 trains a classification machine learning model.

In some implementations, with a given question embedding (eq), source document embedding (es), user context information (fts) and RAG hyperparameter values (hprag), the trained supervised machine learning model (M) acts as a function as shown in Equation 1 which returns the expected feedback value (fᵢ):

fᵢ=M(eq,es,fts,hprag) (1)

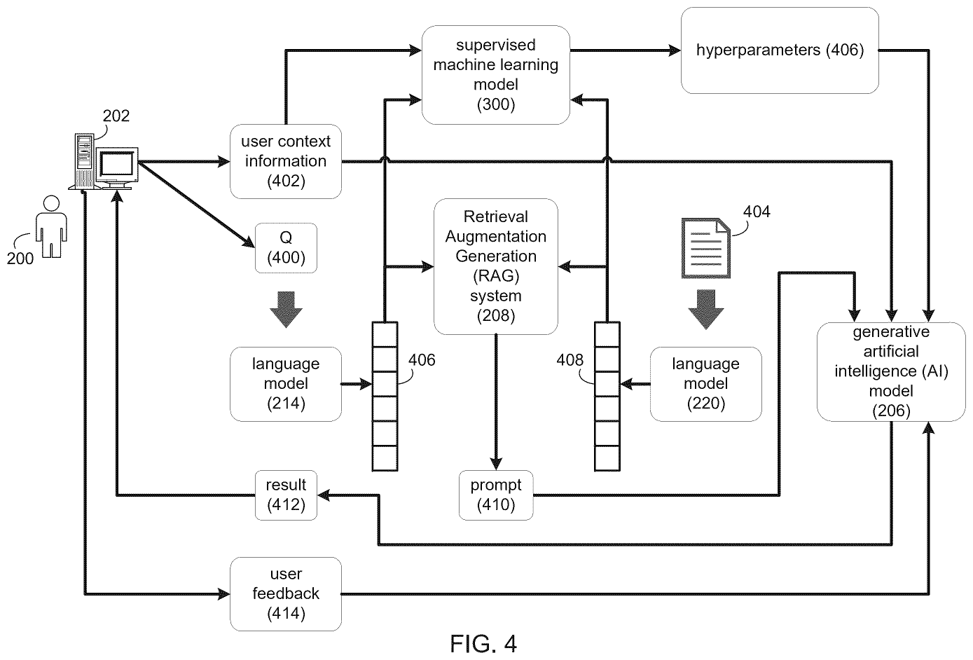

In some implementations, hyperparameter generation process 10 processes 100 a query provided to a generative AI model. Referring also to FIG. 4, a new user query is issued (e.g., query 400). As will be discussed in greater detail below, using query 400, user context information 402 associated with query 400 and/or user 200, and content portion 404, supervised machine learning model 300 generates hyperparameters (e.g., hyperparameters 406) for customizing the processing of query 400 for user 200. For example, hyperparameters play a crucial role in the performance of a generative AI model. In some implementations, hyperparameters influence various aspects of the model's behavior, including its ability to process training data, its efficiency, and the quality of the generated outputs. For example, implementations of hyperparameter generation process 10 concern training hyperparameters and/or inference hyperparameters.

For hyperparameters concerning inference, hyperparameter generation process 10 can customize temperature, top-k sampling, top-p sampling, a maximum number of tokens, a repetition penalty, a length penalty, and/or a presence penalty. In some implementations, temperature controls the randomness of predictions. Higher values lead to a more random output while lower values lead to more deterministic values. The top-k sampling limits the sampling pool of the top-k highest probability tokens. The top-p sampling limits the sampling pool to the smallest set of tokens with a cumulative probability above a threshold (p). The maximum token hyperparameter defines the maximum number of tokens to generate during inference. The repetition penalty penalizes the generative AI model for generating the same token repeatedly. The length penalty adjusts the probability of longer sequences to avoid boas towards shorter or longer responses. The presence penalty promotes the generative AI model to introduce new tokens that have not appeared in the context. Careful tuning of these hyperparameters allows for achieving optimal performance.

In some implementations, processing 100 the query includes generating 112 an embedding for the query by processing the query with a language model. As discussed above, hyperparameter generation process 10 uses a language model (e.g., language model 214) to transform query 400 into an embedding (e.g., query embedding 406). In some implementations, language model 214 (L) takes text as an input (e.g., a free-formed question q), and returns a vector embedding eq=L(q) for that text. This language model may be a Bidirectional Encoder Representations from Transformers (BERT) model, a T5 model, other pre-trained model, or other fine-tuned language model for a specific domain. In one example, language model 214 is not necessarily the same language model as the one used by the generative part of the RAG architecture which generally involves large proprietary models which are used via expensive application programming interface (API) calls. Instead, language model 214 is a smaller language model which is run locally without noticeable costs (neither in latency nor in financial costs since no API calls are required).

In some implementations, hyperparameter generation process 10 processes 102 a content portion retrieved by the Retrieval Augmented Generation (RAG) system for the query. As discussed above, content or content portion 404 includes a document or other form including text and/or other media. In some implementations, processing 102 the content portion includes generating 114 an embedding for the content portion by processing the content portion with the language model. For example, hyperparameter generation process 10 generates 114 a vector embedding (eq) (e.g., content portion embedding 408) from content portion 404 which is matched for similarity with the content so that the top-k most related source content portions are returned and aggregated into an embedding (es).

In some implementations, hyperparameter generation process 10 processes 104 user context information associated with a user providing the query. User context information 402 includes information concerning the user who provided the query (e.g., query 400), the user's computing device from which query 400 originates, and/or query 400 itself. For example, user context information 402 includes a description of the user's query search history, a description of the user's computing device and/or its hardware and/or software resources, a description of the location of the computing device, the language of the query and result, financial constraints associated with the user (that may limit the number of results or number of tokens processed), and other information that impacts the resources allocated for processing query 400 for user 200. In this example, hyperparameter generation process 10 processes user context information 402 and provides these to supervised machine learning model 300.

In some implementations, hyperparameter generation process 10 generates 106 hyperparameters for processing the prompt with the generative AI model by processing the query, the content portion, and the user context information using run-time surrogate model inversion optimization. For example and as shown in FIG. 4, with a trained supervised machine learning model, hyperparameter generation process 10 modifies conventional architecture by dynamically determining and providing hyperparameters 406 to generative AI model 206 based upon, at least in part, the query, the content portion, and/or the user context information processed for they query using run-time surrogate model inversion optimization. In some implementations, run-time surrogate model inversion optimization is a method used in optimization and inverse problem-solving that leverages surrogate models. For example, surrogate models are simplified models that approximate the behavior of more complex, often computationally expensive models. Their purpose is to reduce the computational cost and time required for optimization or solving inverse problems. Inversion involves finding input parameters that produce a given set of observations, essentially reversing a model to find the causes (inputs) from the observed effects (outputs). This is commonly applied in fields like geophysics, medical imaging, and engineering, where direct measurements of certain parameters are difficult or impossible. Optimization is the process of finding the best solution (e.g., minimum cost, maximum efficiency) given a set of constraints and objectives. In the context of inversion, optimization techniques are used to iteratively adjust the input parameters to minimize the difference between the observed data and the data predicted by the model.

Run-time surrogate model inversion optimization begins with surrogate model construction, which involves developing a surrogate model by sampling the input space and evaluating the complex model (i.e., supervised machine learning model 300) at these sample points. Techniques like regression, machine learning, or response surface methods are used to build an approximation that is computationally cheaper to evaluate. Next is inversion, where an objective function is defined to quantify the discrepancy between observed data and model predictions, and the surrogate model is used to evaluate this objective function efficiently. Optimization algorithms, such as gradient-based methods or genetic algorithms, are employed to find the input parameters that minimize the objective function. The surrogate model allows these algorithms to evaluate many candidate solutions quickly. Periodically, the surrogate model is updated with new data points from supervised machine learning model 300 to improve accuracy, ensuring that surrogate model (e.g., supervised machine learning model 300) remains a good approximation over the relevant input space.

The benefits of this approach include efficiency, as it drastically reduces computation time compared to directly using the complex model; scalability, allowing for the handling of larger and more complex problems that would be infeasible with direct methods; and flexibility, as it can be applied across various domains and types of models. Accordingly, surrogate model inversion optimization combines the principles of surrogate modeling, inversion, and optimization to solve complex inverse problems more efficiently and effectively.

In some implementations, generating 106 the hyperparameters includes processing 116 the embedding for the query, the embedding for the content portion, the user context information using the supervised machine learning model; and generating 118 the hyperparameters that maximize feedback associated with the query by performing an optimization of the hyperparameters based upon, at least in part, the embedding for the query, the embedding for the content portion, the user context information. For example, hyperparameter generation process 10 leverages the trained surrogate model (e.g., supervised machine learning model 300) (M) to determine what the optimal set of hyperparameters (hprag) are to maximize the expected user feedback. In other words, hyperparameter generation process 10 solves the following optimization problem as described in Equation 2:

hpragₒₚₜ=argmax_{hprag} M(eq,es fts,hprag). (2)

In some implementations, supervised machine learning model 300 (M) is non-differentiable with respect to hprag. Nonetheless and in one example, optimization may be carried out with gradient-free methods (e.g., Nelder-Mead, Powell that require only function calls (i.e., inference calls to M), etc.). In some implementations, hyperparameter generation process 10 does not introduce additional latency through the run-time surrogate model inversion optimization even though this optimization is performed at run-time, because it will be followed by generative AI model 206's API call which is orders of magnitude slower. Using the run-time surrogate model inversion optimization, hyperparameter generation process 10 is able to determine at run-time, the optimal values of hyperparameters 406 that maximize the prediction of the user satisfaction (e.g., user feedback).

In some implementations, hyperparameter generation process 10 processes 120 the prompt with the hyperparameters using the generative AI model. As shown in FIG. 4, hyperparameter generation process 10 provides the hyperparameters (e.g., hyperparameters 406) that maximize user feedback to generative AI model 206. Accordingly, hyperparameter generation process 10 dynamically generates hyperparameters 406 that are specific to the query, the content portion, and/or the user to achieve the maximal user feedback. In some implementations, the generated hyperparameters are forwarded to the generative AI model 206 along with the initial query (e.g., query 400) (q) and the top-k retrieved source content (e.g., content portion 404) in a prompt (e.g., prompt 410) as in a traditional RAG architecture.

In some implementations, hyperparameter generation process 10 provides 122 a result to the query from the generative AI model associated with the prompt and the hyperparameters. For example and as shown in FIG. 4, using prompt 410, user context information, and hyperparameters 406, generative AI model 206 generates a result (e.g., result 412) for query 400. Hyperparameter generation process 10 provides 122 result 412 to user 200. In some implementations, hyperparameter generation process 10 processes any user feedback associated with result 412 (e.g., user feedback 414) to use in improving generative AI model 206 and/or for subsequent training of supervised machine learning model 300 as described above.

### System Overview

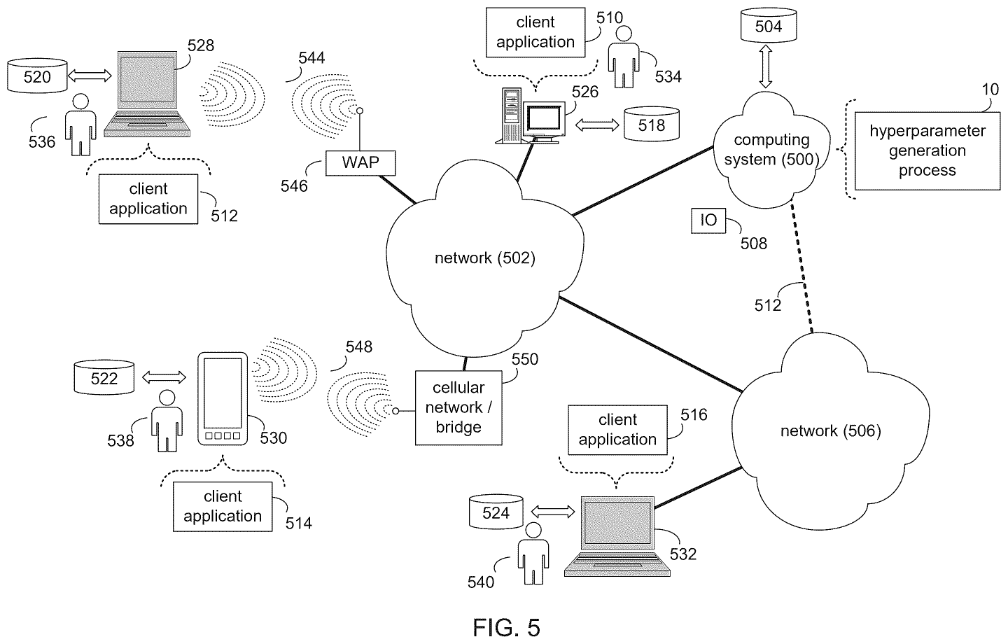

Referring to FIG. 5, a hyperparameter generation process 10 is shown to reside on and is executed by computing system 500, which is connected to network 502 (e.g., the Internet or a local area network). Examples of computing system 500 include: a Network Attached Storage (NAS) system, a Storage Area Network (SAN), a personal computer with a memory system, a server computer with a memory system, and a cloud-based device with a memory system. A SAN includes one or more of a personal computer, a server computer, a series of server computers, a minicomputer, a mainframe computer, a RAID device, and a NAS system.

The various components of computing system 500 execute one or more operating systems, examples of which include: Microsoft® Windows®; Mac® OS X®; Red Hat® Linux®, Windows® Mobile, Chrome OS, Blackberry OS, Fire OS, or a custom operating system (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

The instruction sets and subroutines of hyperparameter generation process 10, which are stored on storage device 504 included within computing system 500, are executed by one or more processors (not shown) and one or more memory architectures (not shown) included within computing system 500. Storage device 504 may include: a hard disk drive; an optical drive; a RAID device; a random-access memory (RAM); a read-only memory (ROM); and all forms of flash memory storage devices. Additionally or alternatively, some portions of the instruction sets and subroutines of hyperparameter generation process 10 are stored on storage devices (and/or executed by processors and memory architectures) that are external to computing system 500.

In some implementations, network 502 is connected to one or more secondary networks (e.g., network 506), examples of which include: a local area network; a wide area network; or an intranet.

Various input/output (IO) requests (e.g., IO request 508) are sent from client applications 510, 512, 514, 516 to computing system 500. Examples of IO request 508 include data write requests (e.g., a request that content be written to computing system 500) and data read requests (e.g., a request that content be read from computing system 500).

The instruction sets and subroutines of client applications 510, 512, 514, 516, which may be stored on storage devices 518, 520, 522, 524 (respectively) coupled to client electronic devices 526, 528, 530, 532 (respectively), may be executed by one or more processors (not shown) and one or more memory architectures (not shown) incorporated into client electronic devices 526, 528, 530, 532 (respectively). Storage devices 518, 520, 522, 524 may include: hard disk drives; tape drives; optical drives; RAID devices; random access memories (RAM); read-only memories (ROM), and all forms of flash memory storage devices. Examples of client electronic devices 526, 528, 530, 532 include personal computer 526, laptop computer 528, smartphone 530, laptop computer 532, a server (not shown), a data-enabled, and a dedicated network device (not shown). Client electronic devices 526, 528, 530, 532 each execute an operating system.

Users 534, 536, 538, 540 may access computing system 500 directly through network 502 or through secondary network 506. Further, computing system 500 may be connected to network 502 through secondary network 506, as illustrated with link line 542.

The various client electronic devices may be directly or indirectly coupled to network 502 (or network 506). For example, personal computer 526 is shown directly coupled to network 502 via a hardwired network connection. Further, laptop computer 532 is shown directly coupled to network 506 via a hardwired network connection. Laptop computer 528 is shown wirelessly coupled to network 502 via wireless communication channel 544 established between laptop computer 528 and wireless access point (e.g., WAP) 546, which is shown directly coupled to network 502. WAP 546 may be, for example, an IEEE 802.11a, 802.11b, 802.11g, 802.11n, Wi-Fi®, and/or Bluetooth® device that is capable of establishing a wireless communication channel 544 between laptop computer 528 and WAP 546. Smartphone 530 is shown wirelessly coupled to network 502 via wireless communication channel 548 established between smartphone 530 and cellular network/bridge 550, which is shown directly coupled to network 502.

### General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be used. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this A, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object-oriented programming language. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet.

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general-purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, not at all, or in any combination with any other flowcharts depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method, executed on a computing device, comprising:
processing a query provided to a generative artificial intelligence (AI) model;
processing a content portion retrieved by a Retrieval Augmented Generation (RAG) system for the query;
processing user context information associated with a user providing the query; and
generating hyperparameters for processing the prompt with the generative AI model by processing the query, the content portion, and the user context information using run-time surrogate model inversion optimization.

2. The computer-implemented method of claim 1, further comprising:
processing the prompt with the hyperparameters using the generative AI model.

3. The computer-implemented method of claim 2, further comprising:
providing a result to the query from the generative AI model associated with the prompt and the hyperparameters.

4. The computer-implemented method of claim 1, wherein processing the query includes generating an embedding for the query by processing the query with a language model.

5. The computer-implemented method of claim 4, wherein processing the content portion includes generating an embedding for the content portion by processing the content portion with the language model.

6. The computer-implemented method of claim 5, wherein generating the hyperparameters includes:
processing the embedding for the query, the embedding for the content portion, the user context information using a supervised machine learning model; and
generating the hyperparameters that maximize feedback associated with the query by performing an optimization of the hyperparameters based upon, at least in part, the embedding for the query, the embedding for the content portion, the user context information.

7. The computer-implemented method of claim 6, further comprising:
processing telemetry data associated with a previous result provided to the user for a previous query.

8. The computer-implemented method of claim 7, further comprising:
training the supervised machine learning model with the telemetry data associated with the previous result including an embedding for the previous query, an embedding for a previous content portion, user context information associated with the user providing the previous query, and feedback associated with the previous result.

9. A computing system comprising:
a memory; and
a processor configured to:
process a query provided to a generative AI model;
process a content portion retrieved by a Retrieval Augmented Generation system for the query;
determine user context information associated with a user providing the query;
generate hyperparameters for processing the prompt with the generative AI model by processing the query, the content portion, and the user context information using run-time surrogate model inversion optimization; and
process the prompt with the hyperparameters using the generative AI model.

10. The computing system of claim 9, wherein the processor is further configured to:
provide a result to the query from the generative AI model associated with the prompt and the hyperparameters.

11. The computing system of claim 9, wherein processing the query includes generating an embedding for the query by processing the query with a language model.

12. The computing system of claim 11, wherein processing the content portion includes generating an embedding for the content portion by processing the content portion with the language model.

13. The computing system of claim 9, wherein generating the hyperparameters includes:
processing the embedding for the query, the embedding for the content portion, the user context information using a supervised machine learning model; and
generating the hyperparameters that maximize feedback associated with the query by performing an optimization of the hyperparameters based upon, at least in part, the embedding for the query, the embedding for the content portion, the user context information.

14. The computing system of claim 13, wherein the processor is further configured to:
process telemetry data associated with a previous result provided to the user for a previous query.

15. A computer program product residing on a non-transitory computer readable medium having a plurality of instructions stored thereon which, when executed by a processor, cause the processor to perform operations comprising:
processing a query provided to a generative AI model;
processing a content portion retrieved by a Retrieval Augmented Generation system for the query;
determining user context information associated with a user providing the query;
generating hyperparameters for processing the prompt with the generative AI model by processing the query, the content portion, and the user context information using run-time surrogate model inversion optimization;
processing the prompt with the hyperparameters using the generative AI model; and
providing a result to the query from the generative AI model associated with the prompt and the hyperparameters.

16. The computer program product of claim 15, wherein processing the query includes generating an embedding for the query by processing the query with a language model.

17. The computer program product of claim 16, wherein processing the content portion includes generating an embedding for the content portion by processing the content portion with the language model.

18. The computer program product of claim 15, wherein generating the hyperparameters includes:
processing the embedding for the query, the embedding for the content portion, the user context information using a supervised machine learning model; and
generating the hyperparameters that maximize feedback associated with the query by performing an optimization of the hyperparameters based upon, at least in part, the embedding for the query, the embedding for the content portion, the user context information.

19. The computer program product of claim 18, wherein the operations further comprise:
processing telemetry data associated with a previous result provided to the user for a previous query.

20. The computer program product of claim 19, wherein the operations further comprise:
training the supervised machine learning model with the telemetry data associated with the previous result including an embedding for the previous query, an embedding for a previous content portion, user context information associated with the user providing the previous query, and feedback associated with the previous result.
